(19) United States
(12) Patent Application Publication
(10) Pub. No.: US 2004/0160085 A1
(43) Pub. Date: Aug. 19, 2004

(54) External support structure for use in the transporting of a house

(76) Inventors: Paul Kerr, Fort Erie (CA); Geoff Mathews, Mississauga (CA)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/754,347

(22) Filed: Jan. 9, 2004

(30) Foreign Application Priority Data
Jan. 23, 2003 (CA) 2,417,033

(51) Int. Cl. B60P 3/335; B60P 3/35

(52) U.S. Cl. 296/168

(57) ABSTRACT

A device, namely a bulk head, for attachment to a house transporter for stabilizing a house during transportation comprising at least one contact surface adapted to be engaged with the house transporter and adapted to be releasably engaged to the exterior of the house and a means for releasably engaging the said contact surface with the outer surface of the house.

### FIELD OF THE INVENTION

The present invention relates to a device for stabilizing buildings during transportation, and more particularly to a device for stabilizing a house or partially completed house, during its transportation or movement.

### DESCRIPTION OF THE PRIOR ART

The manufacturing of completed or partially completed houses within a factory (both of which are referred to herein as a “house” or “houses”) for subsequent transport to the installation location of the house, for example in a subdivision, is well-known. Additionally, the use of a transporter for moving a house from one location to another is well known.

Reference is made to Canadian Patent Number 2,139,622 (Biffis) describing a house transporter in the form of a flatbed truck having a roller-conveyor system to receive and support the house during its transport to the foundation.

While the house is being transported, it is subjected to various forces which lead to racking, twisting, bending and other shape distortions which may cause structural and/or cosmetic damage to the house. Previous efforts to limit such damage, including by overbuilding the house or its components, or the building of additional temporary structural supports into the house, have been pursued but remain expensive, labor intensive, and generally lack efficiency of building material usage.

### SUMMARY OF THE INVENTION

The object of the present invention is to reduce the structural and/or cosmetic damage which may be caused by the movement of a house relative to a house transporter when a house is being transported on a house transporter.

Accordingly, the invention relates to a device for attachment to a house transporter for stabilizing a house during transportation comprising at least one contact surface adapted to be engaged with the house transporter and adapted to be releasably engaged to an exterior of the house and a means for releasably engaging the said contact surface with the exterior surface of the house.

According to a further aspect of the present invention, there is provided a device for attachment to a house transporter for stabilizing a house during transportation of the house, comprising a base portion, the base portion being adapted for placement upon an upper surface of the house transporter; at least one vertical support member connected to the base portion; at least one inclined brace member having a first end and a second end, the at least one inclined brace member being connected to the at least one vertical support member at the first end, and connected to the base portion at the second end; and at least one contact member connected to the at least one vertical support member and adapted to be engaged with the house, the at least one contact member having at least one contact surface which can be releasably engaged to an exterior of the house.

According to a still further aspect of the present invention, there is provided a device for attachment to a house transporter for stabilizing a house during transportation of the house, comprising a base portion, the base portion being adapted for placement upon a load bearing surface of the house transporter; at least one vertical support member connected to the base portion; an inclined brace member having a first end and a second end, the inclined brace member being connected to the at least one vertical support member at the first end, and connected to the base portion at the second end; at least one contact member connected to the at least one vertical support member and adapted to be engaged with the house, the at least one contact member having at least one contact surface which can be releasably engaged to an exterior of the house; and a foot beam member connected and engaged with the at least one inclined brace member at a bottom end of the at least one inclined brace member.

According to another aspect of the present invention, there is provided a system for bracing and stabilizing a house on a house transporter for later transport of the house, comprising loading the house onto the house transporter; positioning a pair of spaced apart first and second bulkheads on the house transporter, the first and the second bulkheads being placed on opposed sides of the house loaded on the house transporter, and each being releasingly engageable with an exterior surface of the opposed sides of the house; and affixing the first and second bulkheads to the house transporter, so as to secure the house therebetween.

According to a still further aspect of the present invention, there is provided a system for bracing and stabilizing a house on a house transporter for later transport of the house, comprising providing a first permanently affixed bulkhead on the house transporter; loading the house onto the house transporter, wherein a first side of the house is brought into abutment with the first permanently affixed bulkhead; positioning a second bulkhead into contact and abutment with a second side of the house loaded on the house transporter, the second bulkhead being removable from the house transporter, each of the first and the second bulkheads being releasingly engageable with an exterior surface of the first and the second side of the house; and affixing the second bulkhead to the house transporter, so as to secure the house between the first and the second bulkheads.

The advantage of the present invention is that it improves the safe and efficient transportation of houses by reducing the effect of various forces which may otherwise lead to racking, twisting, bending and other shape distortions which frequently may cause structural and/or cosmetic damage to the house during transportation. In addition, utilizing the present invention reduces the need to take inefficient compensatory measures such as overbuilding the house or its components, or the building of additional temporary structural supports into the house.

### BRIEF DESCRIPTION OF THE DRAWINGS

A preferred embodiment of the present invention is described below with reference to the accompanying drawings, in which:

FIG. 1 illustrates an embodiment of the present invention installed on one end of a house transporter;

FIG. 2 illustrates an embodiment of the present invention installed on the other end of a house transporter;

FIG. 3 illustrates an embodiment of the present invention.

### DESCRIPTION OF THE PREFERRED EMBODIMENT

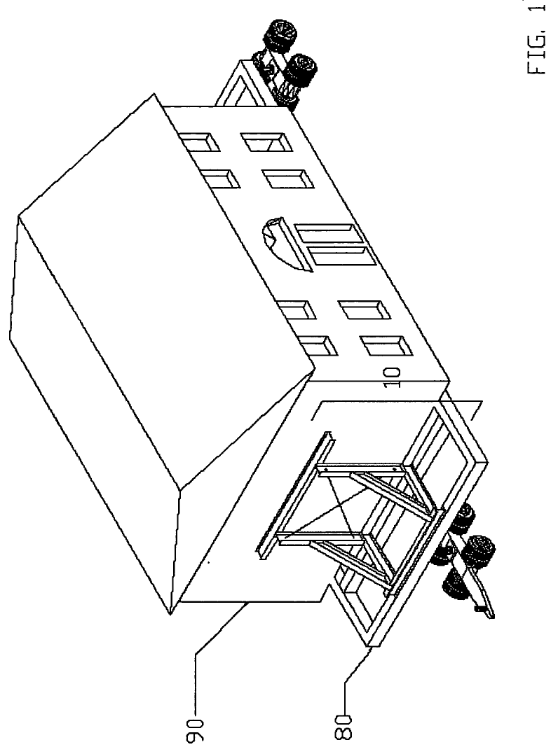

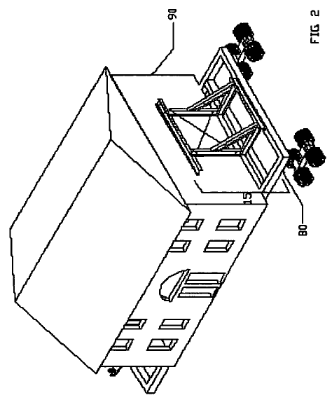

Referring to FIGS. 1 and 2, an embodiment of the present invention is illustrated as a front bulkhead generally shown as 10 in FIG. 1 and a back bulkhead, generally shown as 15 in FIG. 2, installed on a house transporter 80 loaded with a house 90.

The bulkheads 10 and 15 as shown in FIGS. 1 and 2 are securely engaged with the house 90, stabilizing the house 90 so as to reduce racking, shifting, shape distortion or any other movement of the house 90 relative to the transporter 80, during movement of the transporter 80.

It is understood that the device of the present invention is similarly capable of stabilizing a house, a house component or other partially complete building or building component.

In the preferred embodiment the front bulk head 10 is generally used in cooperation with a back bulk head 15. Prior to the movement of a transporter 80 loaded with a house, the front bulk head 10 and back bulk head 15 are securely engaged to the house 90 and to the transporter 80 to thereby securely and stably position the house during movement of the transporter 80.

In the preferred embodiment, both bulk heads are repositionable in two respects. Firstly, they are repositionable to allow them to move between a first position disengaged from the house 90 and a second position in which they are fully engaged with the house. With the bulk heads in a disengaged position, this permits a simplified loading of the house onto the transporter, the bulkheads being subsequently engaged to secure the house before moving the transporter. Similarly, when unloading the house, the bulk heads may be repositioned from the fully engaged position to the disengaged position to permit a simplified removal of the house from the transporter. Secondly the bulkheads are repositionable to allow for the various different sizes of houses which will be moved on the transporter.

When in the fully engaged position, the bulkheads are securely engaged to the transporter, by means which are known to persons skilled in the art, including by way of example only, bolts, pins, etc.

In one embodiment, one bulkhead may be permanently affixed to the transporter 80, the house 90 then being loaded to a position abutting the permanently affixed bulkhead, the other bulkhead being repositionable to allow it to be moved between a disengaged position and a fully engaged position and when in the fully engaged position, the permanently affixed bulkhead and the other bulkhead securely engage the house for transport.

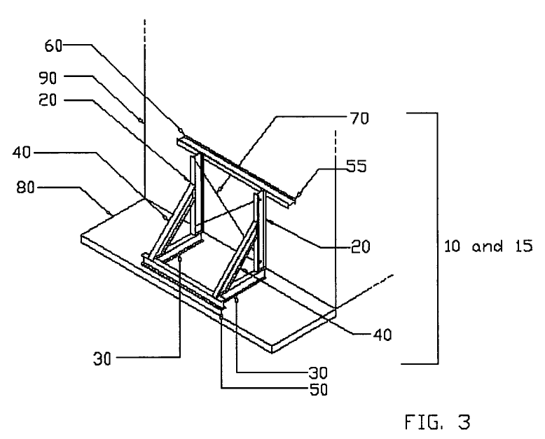

Referring to FIG. 3, in the preferred embodiment, each bulkhead 10 and 15 has a contact surface 55 which in the preferred embodiment is the flange of an “I” shaped beam 60. In the preferred embodiment, two vertical supports 20 securely support the “I” shaped beam 60, and braces 30, 40 and 70 provide additional structural support for the bulkhead. It is understood that a wide variety of different and generally known structures and supports may be used to provide additional or alternative support to the contact surface of the bulkheads, it being further understood that sufficient structural integrity of the bulkhead and the contact surface is required to reduce or eliminate the movement, flexing or distortion of the contact surface and bulkhead.

In one embodiment, the braces 40 are securely engaged with a foot beam 50 which is bolted onto or otherwise similarly fixed in position on the transporter.

In the preferred embodiment, the contact surface 55 of the “I” shaped beam 60 will engage the house 90 generally in the upper portion of the exterior wall in the case of a single storey structure and generally at or near one or more upper floor plates in the case of a multi-storey structure. It is understood that as few as one I” shaped beam 60 and contact surface 55 may be used for each bulkhead, or that as many I” shaped beams 60 and contact surfaces 55 may be used as are required to reduce the motion of the house relative to the transporter. It is also understood that an I” shaped beam 60 and contact surface 55, although typically straight, may be in any other shape as is required to secure satisfactory contact with the house 90.

In the preferred embodiment, the contact surface 55 is steel, it being understood that the contact surface may also have an energy absorbing surface such as rubber affixed thereto to minimize the damage to the exterior wall when the bulkhead is butted against the exterior wall of the house.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A device for attachment to a house transporter for stabilizing a house during transportation, comprising:
at least one contact surface adapted to be engaged with the house transporter and adapted to be releasably engaged to an exterior of the house; and
means for releasably engaging the said contact surface with the exterior of the house.

2. A device for attachment to a house transporter for stabilizing a house during transportation of the house, comprising:
a base portion, the base portion being adapted for placement upon an upper surface of the house transporter;
at least one vertical support member connected to the base portion;
at least one inclined brace member having a first end and a second end, the at least one inclined brace member being connected to the at least one vertical support member at the first end, and connected to the base portion at the second end; and
at least one contact member connected to the at least one vertical support member and adapted to be engaged with the house, the at least one contact member having at least one contact surface which can be releasably engaged to an exterior of the house.

3. The device of claim 2, wherein the base portion is positioned in a substantially horizontal orientation on the upper surface of the house transporter, and wherein the base portion assumes a substantially parallel relationship with the upper surface of the house transporter.

4. The device of claim 2 or 3, wherein the at least one inclined brace member is positioned between the at least one vertical support member and the base portion in order to provide structural support for the device when engaged with the exterior surface of the house.

5. The device of any one of claims 2 to 4, wherein the at least one vertical support member is positioned in substantially perpendicular relationship to the base portion.

6. The device of any one of claims 2 to 5, wherein the at least one contact member is an “I” shaped beam, which is connected to an upper portion of the at least one vertical support member.

7. The device of claim 6, wherein the at least one contact member is positioned in substantially perpendicular relationship to the at least one vertical support member.

8. The device of any one of claims 1 to 7, wherein the contact surface of the at least one contact member is steel.

9. The device of any one of claims 2 to 8, wherein the contact surface of the at least one contact member has an energy absorbing surface affixed thereto, so as to minimize damage to the exterior wall of the house when the device is brought into contact with the exterior of the house.

10. The device of claim 9, wherein the energy absorbing surface affixed to the contact surface is rubber.

11. The device of any one of claims 2 to 10, wherein a foot beam member is connected and engaged with the at least one inclined brace member at a bottom end of the brace member.

12. The device of claim 11, wherein the foot beam member is bolted or fixed to the house transporter.

13. The device of any one of claims 2 to 12, wherein the at least one vertical support member is mounted upon the base portion.

14. A device for attachment to a house transporter for stabilizing a house during transportation of the house, comprising:
a base portion, the base portion being adapted for placement upon a load bearing surface of the house transporter;
at least one vertical support member connected to the base portion;
an inclined brace member having a first end and a second end, the inclined brace member being connected to the at least one vertical support member at the first end, and connected to the base portion at the second end;
at least one contact member connected to the at least one vertical support member and adapted to be engaged with the house, the at least one contact member having at least one contact surface which can be releasably engaged to an exterior of the house; and
a foot beam member connected and engaged with the at least one inclined brace member at a bottom end of the at least one inclined brace member.

15. The device of any one of claims 1 to 14, wherein the at least one contact surface releasably engages an upper portion of the exterior of the house.

16. The device of any one of claims 1 to 14, wherein, in a case where the house to be engaged on the house transporter is a multi-storey structure, the at least one contact surface releasably engages the exterior of the house at or near one or more upper floor plates of the house.

17. The device of any one of claims 1 to 16, wherein a plurality of contact surfaces may be connected to the device, each of the plurality of contact surfaces being releasably engageable with the exterior of the house.

18. The device of any one of claims 1 to 17, wherein, when the device is fully engaged with the exterior of the house, the device is securely fixed to the house transporter.

19. The device of claim 18, wherein the device is securely fixed to the house transporter by bolts, pins, clasps or clamps.

20. The device of any one of claims 1 to 19, wherein the device is repositionable and operably able to move from a first position of disengagement with the house to a second position in which the device is fully engaged with the house.

21. The device of any one of claims 2 to 20, wherein the at least one contact member is connected to and supported by two vertical support members, the at least one contact member being connected to an upper portion of each of the vertical support members.

22. A system for bracing and stabilizing a house on a house transporter for later transport of the house, comprising:
loading the house onto the house transporter;
positioning a pair of spaced apart first and second bulkheads on the house transporter, the first and the second bulkheads being placed on opposed sides of the house loaded on the house transporter, and each being releasingly engageable with an exterior surface of the opposed sides of the house; and
affixing the first and second bulkheads to the house transporter, so as to secure the house therebetween.

23. The system of claim 22, wherein, when the house is to be loaded unto the house transporter, the system further comprises:
placing the first and second bulkheads to a first position of disengagement with the house;
loading the house onto the house transporter;
moving the first and second bulkheads from the first position to a second position to fully engage the house and secure the house on the house transporter;
transporting the house to a placement location; and
repositioning the first and second bulk heads from the second position to the first position of disengagement with the house, whereby the house may be removed from the house transporter.

24. A system for bracing and stabilizing a house on a house transporter for later transport of the house, comprising:
providing a first permanently affixed bulkhead on the house transporter;
loading the house onto the house transporter, wherein a first side of the house is brought into abutment with the first permanently affixed bulkhead;
positioning a second bulkhead into contact and abutment with a second side of the house loaded on the house transporter, the second bulkhead being removable from the house transporter, each of the first and the second bulkheads being releasingly engageable with an exterior surface of the first and the second side of the house; and
affixing the second bulkhead to the house transporter, so as to secure the house between the first and the second bulkheads.

25. The system of claim 24, wherein, when the house is to be loaded unto the house transporter, the system further comprises:
loading the house onto the house transporter into abutment with the first permanently affixed bulkhead on the house transporter;
placing the second bulkhead into contact with an exterior of a second side of the house to fully engage the second bulkhead to the exterior of the second side of the house and secure the house on the house transporter;
affixing the second bulkhead to the house transporter, so as to secure the house between the first permanently affixed bulkhead and the second bulkhead;
transporting the house to a placement location;
disengaging the second bulkhead from engagement with the exterior of the second side of the house; and
removing the house from the house transporter for placement at the placement location.

26. The system of any one of claims 22 to 25, wherein the bulkheads each comprise:
a base portion, the base portion being adapted for placement upon a load bearing surface of the house transporter;
at least one vertical support member connected to the base portion;
an inclined brace member having a first end and a second end, the inclined brace member being connected to the at least one vertical support member at the first end, and connected to the base portion at the second end;
at least one contact member connected to the at least one vertical support member and adapted to be engaged with the house, the at least one contact member having at least one contact surface which can be releasably engaged to the exterior of the house; and
a foot beam member connected and engaged with the at least one inclined brace member at a bottom end of the at least one inclined brace member.

27. The system of claim 22 or 23, wherein the step of affixing the first and the second bulkhead to the house transporter further comprises affixing foot beam members to a bottom end of each of the first and the second bulkhead, whereby the foot beam members are then affixed and secured to the house transporter.

28. The system of claim 24 or 25, wherein the step of affixing the second bulkhead to the house transporter further comprises affixing foot beam members to a bottom end of the second bulkhead, whereby the foot beam members are then affixed and secured to the house transporter.
